(19) United States
(12) Patent Application Publication
(10) Pub. No.: US 2026/0019393 A1
(43) Pub. Date: Jan. 15, 2026

(54) System for creating combining and sending file-voice messages over chats in communication apps

(71) Applicant: Yotam Zakai, Ramat Gan (IL)

(72) Inventor: Yotam Zakai, Ramat Gan (IL)

(21) Appl. No.: 18/766,670

(22) Filed: Jul. 9, 2024

(51) Int. Cl. H04L 51/10; G06F 3/16

(52) U.S. Cl. CPC H04L 51/10; G06F 3/16

(57) ABSTRACT

A computer system for creating and sending a combined file-voice message over a chat in a communication app from a computing device of a user to a computing device of a contact that comprises a processing device running on the user's computing device. The system is configured to display on the screen of the user's computing device a selected file, display on the screen a recording-combining-sending button that is configured to record a voice message, to combine the recorded voice message with the selected file, and to send the combined file-voice message over the chat, record the voice message, combine the voice message with the selected file for creating the combined file-voice message, send the combined file-voice message over the chat to the computing device of the contact.

### TECHNICAL FIELD

The present invention refers to a computer system for creating, combining and sending file-voice messages over chats in communication apps.

### BACKGROUND ART

It is common now to send files about work matters through chats in communication apps, and regularly people make written comments (text messages) about these files or about their content. The present invention discloses a system that significantly facilitates communication between people in this regard.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a schematic illustration of the user's computing device (11).

FIG. 2 is a schematic illustration of the contact's computing device (12).

### THE INVENTION

The main objective of the present invention is to provide a computer system (10) for creating and sending a combined file-voice-message (51) over a chat (20) in a communication app from a computing device (11) of a user to a computing device (12) of a contact. The system (10) comprises the processing devices (13) that are running on the computing devices of the user and of the contact. The term computing device refers to any kind of computer with an internet connection, such as a desktop computer, a laptop, a tablet, a smartphone and the like. The term “file” in this disclosure and in the claims means any kind of file that can be sent over chats of communication apps, such as image file types (such as jpeg, png, tif, gif), document file types (such as pdf, docx, xlsx, pptx), audio file types, videos, web file types, and any other kind of files that can be sent over chats in messaging apps.

The computer system is configured to:
A. Display, by the processing device in the user's computing device, on a screen (14) of the user's computing device a selected file (15). The file may be selected by the user from the memory (16) in his computing device, from the chat (20), from another chat, from a cloud, or from a browser. The important part in this regard is that the file is displayed (but not necessarily opened) on the screen of the computing device of the user.
B. Display, by the processing device of the user's computing device, on the screen of the user's computing device a recording-combining-sending button (52) that is configured to do the following: to record a voice message (53), to combine the recorded voice message with the selected file (for creating the combined file-voice message), and to send the combined file-voice message over the chat to the contact's computing device.
C. Record, by the processing device in the user's computing device, the voice message, combine the voice message with the selected file and create the combined file-voice message;
D. Send, by the processing device in the user's computing device, the combined file-voice message over the chat to the computing device of the contact.
E. Display, by the processing device in the computing device of the contact, the combined file-voice message on a screen (14) of the contact's computing device. It is possible that the combined file-voice message will be designed to be displayed on the screens of the user and/or of the contact in such a way that the voice message can be played and heard while the selected file is opened and viewed on the screens.
F. The combined file-voice message may further include a graphical symbol (54) on the combined file-voice message to notify that this file includes a voice message.

The recording-combining-sending button may be visible on the screen of the user's smartphone or may be invisible; one button may be used to process the functions of the recording, the combining and the sending of the combined file-voice message over the chat or two or more buttons. The term “displaying” with regard to these buttons is illustrative. The use of these buttons may be done by tapping on or touching a graphic symbol on the screen of the smartphone or physical buttons on it, by tapping on or touching the screen of the smartphone in a certain way, by tilting the smartphone in a certain way, or in any other way that can be used to select an option or to execute an action on mobile devices such smartphones with touch screens and the term tapping in this disclosure and in the claims means any way of activating such buttons. The term ‘displaying a button’ in this disclosure and in the claims means: providing the user with the option to execute the actions that these ‘buttons’ are designed to execute or perform, even though the user's eye doesn't really see a button or anything on the screen. For example, placing three fingers on the screen and quickly sliding them down can cause some action on the device.

The system of the present invention can be realized and performed through a feature that the operators of communication apps can add to their communication apps by updating their apps to enable the users to combine a voice message with selected files and to send the combined file-voice message over the chat, or by computer entities by upgrading their operations system, or by virtual keyboards providers.

The present invention meets a real and specific need, which is not answered by the present art: to select a file that is displayed on the screen, to record a voice message, to combine the recording voice message with the selected file, and to send the combined file-voice message over the chat.

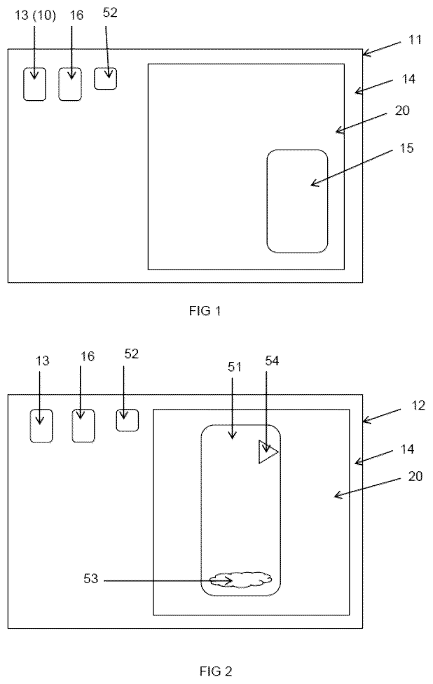

FIG. 1 is a schematic illustration of the user's computing device (11) and FIG. 2 is a schematic illustration of the contact's computing device (12).

The application of the present invention can be in a variety of ways: for example, the user selects a file (from the library on the computer or one that is displayed on the screen), presses on the recording-combined-sending button (52) to make a recording (the voice message) that will be combined with the selected file. After the recording is done, the combined file is displayed on the screen, and the user can click on buttons whose purpose is to send the combined file to the contact via the chat, and there can be several buttons to perform the task, for example: press a “share” button to select the communication application of the intended chat, press a button to select the contact, and then click “send” button to send the combined file over the chat. The term ‘recording-combining-sending button’ may include all these buttons and/or include all these functions and/or a part of them. The route described above is more or less based on the way a file is selected on a smartphone and sent to a contact over a chat in a communication application, and this is for illustration purposes only, and is not intended to limit the scope or the application of the invention. Or for example, the user is in the chat, clicks on the attach file button to be send, directories appear on the screen, the user selects a directory, then selects a file, clicks on the ‘recording-combining-sending button’ button to record the voice message and to combine it with the recorded voice message, then clicks the ‘send’ button. The route described above is more or less based on how users in a chat choose a file to send through the chat.

It is possible from a programming perspective to combine the voice message and the selected file (such as an image, doc, or PDF) to send them together over chats and display them together in a graphical representation. Here's an overview of how this may done: File Combination: first, to bundle the voice message and the selected file together. This step could be achieved by: Packaging into a Container: Using formats like ZIP to combine the audio file and the document/image file. Embedding: Embed the audio file into the document if the document format supports it (e.g., embedding audio in a PDF), but this is optional. Representation: To ensure the files are displayed together: it is possible to add metadata that links the files together. Custom Formats: Create a custom file format or a wrapper that understands both files and displays them accordingly. Transmission: Sending the combined file over chats can be done using standard Protocols: Utilize existing chat protocols that support file attachments (e.g., WhatsApp, Telegram, Slack); or Custom Protocols: Developing a custom protocol if needed. The Display: To display them together in the chat: Custom Client: Develop a custom chat client that knows how to handle the combined file and present it. Embedded Players: Use embedded players to display documents and play audio files together within the chat application. Sending and Displaying: Sending: Use an API provided by the chat service. Displaying: Modify the chat client to understand the ZIP file and render the audio and document together.

In summary, combining and sending files in the manner described above involves bundling the files, using metadata, and customizing the client for display. This approach can be tailored based on the specific requirements of the chat platform and the capabilities of the chat client.

The term “combine” in the context of the present invention as detailed above and defined in the claims, means, connection or binding or linking of the two files (the file expressing the voice message and the file expressing the selected file) so that they can be sent together, as one sends one file, through the chat. And also, their presentation on the screen, for example in a chat, in such a way that they will appear to the human eye as an integrated, integral thing, for example, that the combined file will be displayed on the screen as today such selected files are displayed on computing screens, accompanied by something graphic that will indicate that it includes one or more voice messages, For example, a PLAY symbol, in the bottom corner of the file.

What is claimed is:

1. A computer system for creating and sending a combined file-voice message over a chat in a communication app from a computing device of a user to a computing device of a contact that comprises a processing device running on the user's computing device, said computer system is configured to:
display, by the processing device in the user's computing device, on a screen of the user's computing device a selected file;
display, by said processing device, on said screen a recording-combining-sending button that is configured to record a voice message by the computing device of the user, to combine the recorded voice message with the selected file for creating the combined file-voice message, and to send the combined file-voice message over the chat to the computing device of the contact;
record, by said computing device, said voice message;
combine, by said processing device, said voice message with said selected file for creating the combined file-voice message;
send, by the user's computing device, the combined file-voice message over the chat to the computing device of the contact;
wherein enabling a processing device in the contact's computing device to display the received combined file-voice message on a screen of the contact's computing device; and
wherein said voice message is designed to be played and heard on the contact's computing device and said selected file is designed to be opened and viewed on the computing device of the contact.
